(19) United States
(12) Patent Application Publication
(10) Pub. No.: US 2003/0210541 A1
(43) Pub. Date: Nov. 13, 2003

(54) Lamp string with panel illuminators

(76) Inventor: Jang Jin Long, Chu-Pei City (TW)

Correspondence Address: SUPREME PATENT SERVICES, POST OFFICE BOX 2339, SARATOGA, CA, 95070, US

(21) Appl. No.: 10/142,493

(22) Filed: May 9, 2002

(51) Int. Cl. F21V 9/16

(52) U.S. Cl. 362/84; 362/249; 362/252; 362/806

(57) ABSTRACT

A lamp string includes a number of panel illuminators electrically connected to cables that are selectively connected to a wall outlet. Drivers are incorporated in the cables for driving the panel illuminators. Each panel illuminator includes an electro-luminescent element for giving off electro luminescent. The panel illuminators are divided into several groups each associated with an individual driver. If desired, any panel illuminator can be associated with a vibration device for causing vibration of the panel illuminator. Preferably, the panel illuminator that is associated with a vibration device is made in the form of a flying insect or animal.

### FIELD OF THE INVENTION

The present invention relates generally to a decorative lamp string, such as Christmas lamp string, and in particular to a lamp string comprised of electro luminescent panel illuminators for safety, power saving and versatility of decoration purposes.

### BACKGROUND OF THE INVENTION

Decorative lamp strings, such as Christmas lamp strings, are usually comprised of tungsten filament based lamps covered by shields of different colors for giving off lights of different colors. A length of the lamp string is hung on and surrounding for example a tree for formation of different light and colorful patterns in the night. However, such conventional lamp strings have limited decorative effectiveness and may cause high temperature due to the tungsten filaments. This may result in fire if the high temperature is not properly controlled and monitored.

Thus, it is desired to provide an electro luminescent based lamp string for overcoming the above problems.

### SUMMARY OF THE INVENTION

An object of the present invention is to provide a lamp string that does not generate high temperature so as to enhance operation safety.

Another object of the present invention is to provide a lamp string comprised of panel illuminators for versatility of decoration.

A further object of the present invention is to provide a lamp string having reduced power consumption.

A further object of the present invention is to provide a lamp string comprised of movable panel illuminators for enhanced decoration.

To achieve the above objects, in accordance with the present invention, there is provided a lamp string comprising a number of panel illuminators electrically connected to a cable network that is selectively connected to a wall outlet. Drivers are incorporated in the cable network for driving the panel illuminators. Each panel illuminator comprises an electro-luminescent element for giving off electro luminescent. The panel illuminators are divided into several groups each associated with an individual driver. If desired, a panel illuminator can be associated with a vibration device for causing vibration of the panel illuminator. Preferably, the panel illuminator that is associated with a vibration device is made in the form of a flying insect or animal. If desired, the panel illuminators may have “blank” surface to allow a user to put down sentences or wishes.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic view of a lamp string constructed in accordance with a first embodiment of the present invention;

FIG. 2 is a schematic view of a lamp string constructed in accordance with a second embodiment of the present invention;

FIG. 3A is a plan view of a panel illuminator of the lamp string of the present invention; and

FIG. 3B is a side elevational view of the panel illuminator illustrating a vibrator incorporated therewith.

### DETAILED DESCRIPTION OF THE INVENTION

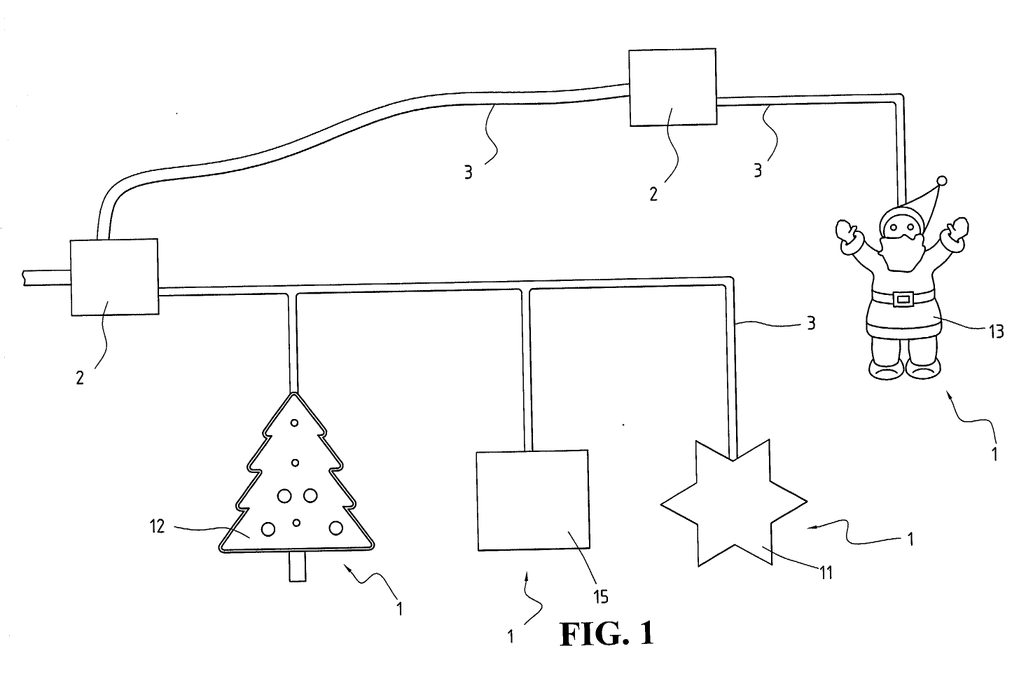

With reference to the drawings and in particular to FIG. 1, a lamp string constructed in accordance with a first embodiment of the present invention comprises a number of panel illuminators 1 electrically connected to a cable network comprised of cables 3. The panel illuminators 1 can be any panel comprised of electro luminescent generators, such as electro-luminescent elements made in the form of a panel. The electro luminescent technology and the panel illuminator are known in the art and no further detail will be given herein.

In the embodiment illustrated in FIG. 1, the panel illuminators 1 are respectively made in the form of a “tree” (designated with reference numeral 12), a “star” (designated with reference numeral 11), a “Santa Claus” (designated with reference numeral 13) or a rectangular “blank” panel (designated with reference numeral 15) that has a blank surface. Other shaper, patterns and/or figures can be formed with the panel illuminator. The colors of the lights emitted from the panel illuminators 11, 12, 13 can be the same or different. The panel illuminator can be comprised of portions made of electro-luminescent elements of different colors for generation of lights of different colors. For example, the cap of the Santa Claus 13 can be red, while the beard is white.

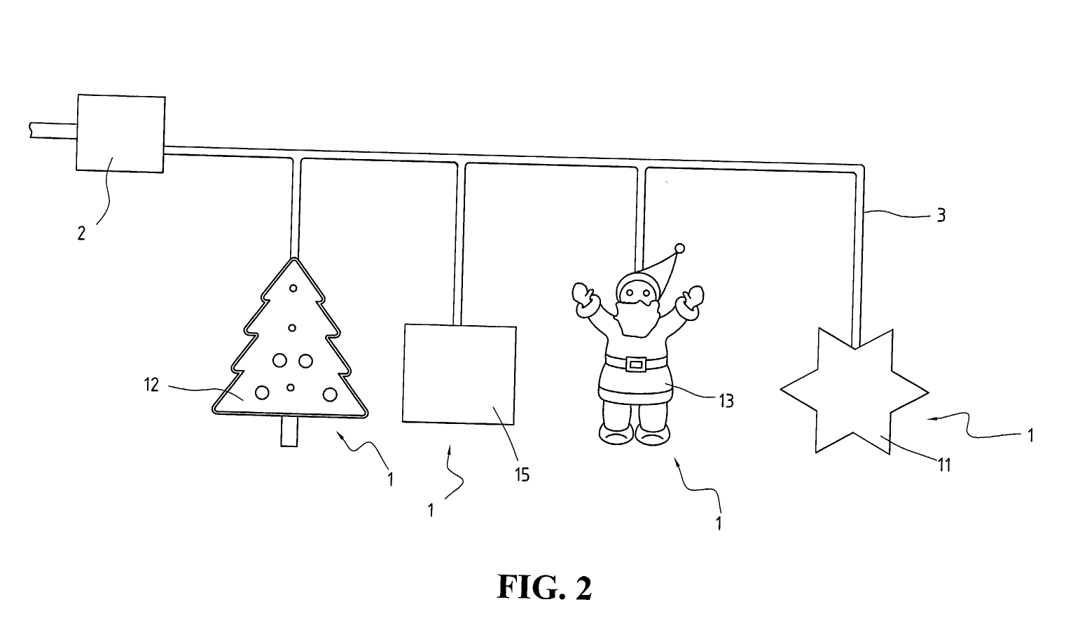

Circuit drivers 2 are added in the cables 3 for controlling and driving the panel illuminators 1. The panel illuminators 1 can be divided into different groups associated with individual drivers 2. Each driver 2 may comprise circuit to for example change frequency of the input power and increase/decrease the voltage of the input power. The lamp string of the present invention may comprise 10-30 panel illuminators 1 and each panel illuminator 1 can be lit in different ways with different colors according to the driver 2 associated with the group to which the particular panel illuminator 1 belongs. Thus, a number of drivers 2 may be incorporated in the lamp string for control purposes. Alternatively and as shown in a second embodiment of the present invention illustrated in FIG. 2, there may be only one driver 2 incorporated in the lamp string if all the panel illuminators 1 are emitting light of the same characteristics, such as same color and same brightness.

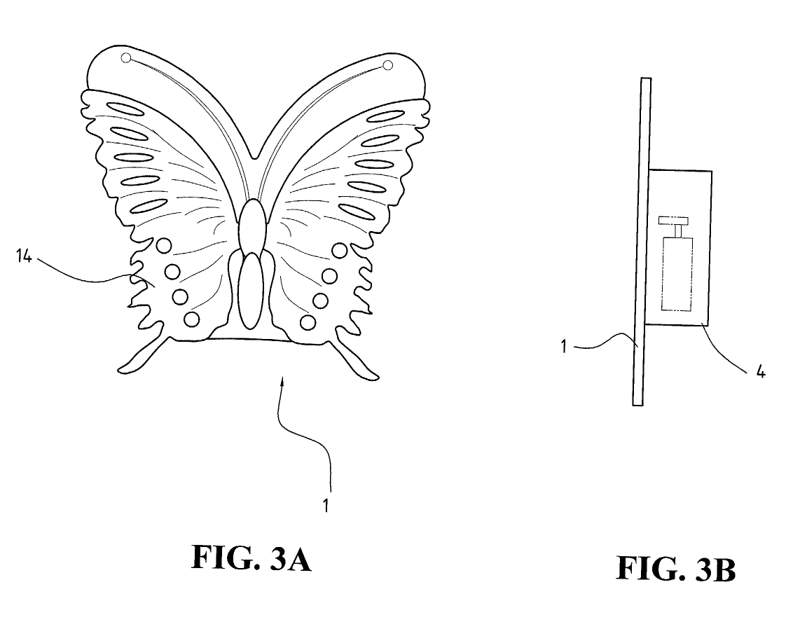

Also referring to FIGS. 3A and 3B, in accordance with another embodiment of the present invention, a vibration generator 4 is mounted to the backside of a panel illuminator 1. In the embodiment illustrated in FIGS. 3A and 3B, the panel illuminator 1 is made in the form of a flying insect or animal, such as a butterfly. When actuated, the vibration generator 4 causes the panel illuminator 1 to move and vibrate, making it look like a “live” butterfly. The vibration generator 4 can be any suitable means that causes vibration when actuated. For example, the vibration generator 4 comprises an eccentric mass coupled to a spindle of an electrical motor. It is apparent that an independent driver is needed for the panel illuminator that comprises a vibration generator 4.

In use, the lamp string can be hung on and surrounding for example a tree, such as a Christmas tree, with the cables 3 connected to a wall outlet. The panel illuminators 1 are attached to different positions around the tree. The blank surface of the “blank” panel 15 allows a person to put down a sentence or a wish with a pen or other suitable tools.

In addition, the lamp string of the present invention can be combined with regular lamp string by electrically connecting the regular lamp string to a joint of the cables 3. If desired, the driver 2 can be modified to comprise circuit for driving the regular lamp string.

Although the present invention has been described with reference to the preferred embodiments thereof, it is apparent to those skilled in the art that a variety of modifications and changes may be made without departing from the scope of the present invention which is intended to be defined by the appended claims.

What is claimed:

1. A lamp string comprising a number of panel illuminators electrically connected to a cable network that is adapted to connect to an external power source and driver means for driving the panel illuminators wherein each panel illuminator comprises an electro luminescent generation element.

2. The lamp string as claimed in claim 1, wherein the panel illuminators have different shapes.

3. The lamp string as claimed in claim 1, wherein the panel illuminators have same shape.

4. The lamp string as claimed in claim 1, wherein the panel illuminators give off lights of the same color.

5. The lamp string as claimed in claim 1, wherein the panel illuminators give off lights of different colors.

6. The lamp string as claimed in claim 1, wherein at least one of the panel illuminators comprises portions giving off lights of different colors.

7. The lamp string as claimed in claim 1, wherein the panel illuminators are divided into groups, each group being associated with an individual driver.

8. The lamp string as claimed in claim 1, wherein at least one of the panel illuminators comprises a vibration device mounted thereto for causing vibration of the panel illuminator.

9. The lamp string as claimed in claim 8, wherein the panel illuminator is made in the form of a flying animal.

10. The lamp string as claimed in claim 1, wherein the electro luminescent generation device comprises an electro-luminescent element.

11. The lamp string as claimed in claim 1, wherein at least one of the panel illuminators comprises a blank surface adapted to allow a user to put down words thereon.
